(19) United States
(12) Patent Application Publication
(10) Pub. No.: US 2019/0044396 A1
(43) Pub. Date: Feb. 7, 2019

(54) ELECTRIC MACHINE AND CONFIGURATION METHOD

(71) Applicant: Jaguar Land Rover Limited, Whitley, Coventry, Warwickshire (GB)

(72) Inventors: Istvan KIRALY, Whitley, Coventry (GB); Alexandros MICHAELIDES, Whitley, Coventry (GB)

(21) Appl. No.: 16/074,036

(22) PCT Filed: Jan. 30, 2017
(86) PCT No.: PCT/EP2017/051941

§ 371 Date: Jul. 30, 2018

(30) Foreign Application Priority Data
Feb. 15, 2016 (GB) 1602630.4

(51) Int. Cl. H02K 1/14

(52) U.S. Cl. CPC H02K 1/146; H02K 15/022

(57) ABSTRACT

The present disclosure relates to a method of configuring an electric machine (1). The electric machine (1) has a rotor (5) having Nₚ rotor poles (12), where Nₚ is the number of rotor poles (12); and a stator (4) having one or more cut-out sector and Nₜ stator teeth (9), where Nₜ is the number of stator teeth (9). The electric machine (1) is configured in dependence on a base model (Base1) having N_{tBase} stator teeth (9) and rotor poles (12), where N_{tBase} and N_{pBase} are both integers greater than one and N_{pBase} is an odd number. The method includes calculating Nₚ using the equation (I) and calculating Nₜ using the equation (II); Where: Nₚ is the number of rotor poles (12) and is greater than one; Nₜ is the number of stator teeth (9) and is greater than one; N_{pBase} is the number of rotor poles (12) in the base model; N_{tBase} is the number of stator teeth (9) in the base model; k is a non-negative integer; and f is a positive integer. The present disclosure also relates to an electric machine (1) having a topology configured according to these equations. Furthermore, the present disclosure relates to a vehicle (2) including said electric machine (1).

$$\begin{matrix}{N}_{p} = \frac{1 - {( - 1 )}^{f}}{2} + 2 \cdot k + {N}_{pBase} \cdot f & ( I ) \\ {N}_{t} = {N}_{tBase} \cdot f & ( II )\end{matrix}$$

### TECHNICAL FIELD

The present disclosure relates to an electric machine and configuration method. More particularly, but not exclusively, the present disclosure relates to a method of configuring an electric machine; and to an electric machine for use in a vehicle. The present disclosure also relates to a vehicle including an electric machine.

### BACKGROUND

It is known to provide an electric machine in a vehicle to generate a tractive force for propelling the vehicle. The electric machine typically includes a stator and a rotor. The electric machine may be the sole means of propulsion for the vehicle, or may be used in conjunction with another torque generating machine, such as an internal combustion engine. In certain applications there may be constraints on the available packaging space for the electric machine. It may not be possible for the stator to have a complete annular configuration (i.e. extending through 360°). However it is desirable to use the maximum available rotor diameter to develop the maximum torque. One possible application where packaging limitations may arise is a hybrid electric vehicle in which the electric machine may be disposed in a housing of a transmission coupled to an internal combustion engine. In this application, external devices may impinge on to the transmission housing, thereby reducing the available volume in the transmission housing to accommodate the electric machine.

It is known from the applicant's earlier applications GB1303653.8 and PCTPCT/EP2013/074280 to provide an electric machine having a stator formed from a plurality of segments. The segments may be configured to form a part-annular stator. In one configuration, the stator is C-shaped in order to increase the volume of the electric machine.

A potential shortcoming of electric machines having a part-annular stator is that certain rotor and stator configurations have an electromagnetic imbalance. This imbalance may limit the number of possible options for connect the coils. In turn, this may affect manufacturability of the electric machine.

At least in certain embodiments, the present invention seeks to provide a method and apparatus which overcomes some of the aforementioned shortcomings.

### SUMMARY OF THE INVENTION

Aspects of the present invention relate to a method of configuring an electric machine, an electric machine, and to a vehicle as claimed in the appended claims.

According to an aspect of the present invention there is provided a method of configuring an electric machine (1),
the electric machine (1) comprising:
   a rotor (5) having Nₚ rotor poles (12), where Nₚ is the number of rotor poles (12); and
   a stator (4) having one or more cut-out sector and Nₜ stator teeth (9), where Nₜ is the number of stator teeth (9);
the method comprising configuring the electric machine (1) in dependence on a base model (Base1) having N_{tBase} stator teeth (9) and N_{pBase} rotor poles (12), where N_{tBase} and N_{pBase} are both integers greater than one and N_{pBase} is an odd number;
wherein Nₚ is calculated using the equation:

$${N}_{p} = \frac{1 - {( - 1 )}^{f}}{2} + 2 \cdot k + {N}_{pBase} \cdot f$$

and Nₜ is calculated using the equation:

Nₜ=N_{tBase}·f

Where: Nₚ is the number of rotor poles (12) and is greater than one;
Nₜ is the number of stator teeth (9) and is greater than one;
N_{pBase} is the number of rotor poles (12) in the base model;
N_{tBase} is the number of stator teeth (9) in the base model;
k is a non-negative integer; and
f is a positive integer.

This method facilitates determination of the parameters of the electric machine, such as the topology of the rotor and stator, in dependence on a base model. The number of stator teeth and rotor poles are determined. At least in certain embodiments, the method allows the magnetic balance of the electric machine to be optimised. The topologies derived from this method are usable in packages where a prior art electric machine having an arcuate stator extending through 360° could not be used, for example due to packaging constraints.

The stator includes one (or more) cut-out sector(s) and, in transverse section, has a part-annular configuration occupying less than 360°. This arrangement enables implementation of the electric machine in package-restricted applications. The method may comprise calculating a sector angle α of the one or more cut-out sector(s) using the equation:

$$α = \frac{\frac{1 - {( - 1 )}^{f}}{2} + 2 \cdot k}{\frac{1 - {( - 1 )}^{f}}{2} + 2 \cdot k + {N}_{pBase} \cdot f} \cdot 360$$

Where: α is the sector angle of the cut-out sector in the stator.

The method facilitates calculation of the sector angle of the cut-out sector and may help to define appropriate teeth-pole combinations for the electric machine.

The method may comprise calculating an angular pitch β of the teeth in the stator using the equation:

$$β = \frac{360 - α}{f \cdot {N}_{tBase}}$$

Where: β is the angular pitch of teeth in the stator.

The angular pitch β is the angle between adjacent teeth in the stator. It will be understood that the angular pitch of teeth is not an integer multiple of 360°. Accordingly, there is no equivalent configuration of an electric machine having an arcuate stator extending through 360° (i.e. without a sector cut-out).

The base model may have the following configuration:
N_{tBase}=6; and
N_{pBase}=5.

According to a further aspect of the present invention there is provided an electric machine comprising a rotor and a stator, the stator having a sector cut-out; wherein the electric machine is configured in dependence on a base model having N_{tBase} stator teeth and N_{pBase} rotor poles, where N_{tBase} and N_{pBase} are both integers greater than one and N_{pBase} is an odd number;
the rotor having Nₚ rotor poles, wherein Nₚ is defined by the equation:

$${N}_{p} = \frac{1 - {( - 1 )}^{f}}{2} + 2 \cdot k + {N}_{pBase} \cdot f$$

the stator having Nₜ stator teeth, where Nₜ is defined by the equation:

Nₜ=N_{tBase}·f

Where: Nₚ is the number of rotor poles and is greater than one;
Nₜ is the number of stator teeth and is greater than one;
N_{pBase} is the number of rotor poles in the base model;
N_{tBase} is the number of stator teeth in the base model;
k is a non-negative integer; and
f is a positive integer.

The stator includes one or more cut-out sector and, therefore, has a part-annular configuration which occupies less than 360°. This arrangement enables implementation of the electric machine in package-restricted applications. This is only valid for certain topologies and combinations of stator and rotor poles. A sector angle α of the one or more cut-out sector may be defined by the equation:

$$α = \frac{\frac{1 - {( - 1 )}^{f}}{2} + 2 \cdot k}{\frac{1 - {( - 1 )}^{f}}{2} + 2 \cdot k + {N}_{pBase} \cdot f} \cdot 360$$

Where: α is the sector angle of the cut-out sector in the stator.

An angular pitch β of the teeth in the stator may be defined by the equation:

$$β = \frac{360 - α}{f \cdot {N}_{tBase}}$$

Where: β is the angular pitch of teeth in the stator.

The base model may have the following configuration:
N_{tBase}=6; and
N_{pBase}=5.

The non-negative integer k may be one (k=1); and the positive integer f may be three (f=3). The stator may have eighteen stator teeth; and the rotor may have eighteen (18) poles. The sector angle α of the one or more cut-out sector may be 60°. If the stator comprises more than one cut-out sector, the sector angle α defines the combined angular extent of said cut-out sectors. The angular pitch β of the teeth in the stator may be 16.67°.

The stator can be segmented into one or more segments. The one or more segment may each have a self-contained flux path. The tooth number values of each segment could be eighteen (18), nine (9), six (6) or two (2). The design has particular details that enable better modular design. The dimensions of the segments may be configured to reduce torque ripple and voltage harmonics.

The stator comprises one or more cut-out segment. This arrangement has particular application where limited space is available for the electric machine. For example, when installed in a vehicle or the like, there may be packaging constraints which impinge on or limit the available space for the electric machine. The packaging constraint may, for example, be the result of packaging a clutch mechanism or other mechanical device, such as a power split device, in close proximity to the electric machine. By including one or more cut-out segment in the stator, the diameter of the rotor may be increased (compared to an electric machine having an annular stator). At least in certain embodiments, this may provide a higher maximum torque. Furthermore, there may be more space available for coils on the stator teeth. The teeth/pole ratio may be lower than 3/2 which is conventional for concentrated winding machines. This may enable higher torque density or lower current density values.

According to a further aspect of the present invention there is provided a method of configuring an electric machine (1),
the electric machine (1) comprising:
   a rotor (5) having Nₚ rotor poles (12), where Nₚ is the number of rotor poles (12) and is greater than one; and
   a stator (4) having one or more cut-out sector and Nₜ stator teeth (9), where Nₜ is the number of stator teeth (9) and is greater than one;
the method comprising configuring the electric machine (1) in dependence on a base model (Base2) having N_{tBase} stator teeth (9) and N_{pBase} rotor poles (12), where N_{tBase} and N_{pBase} are both integers greater than one and N_{pBase} is an even number;
wherein Nₚ is calculated using the equation:

Nₚ=(2·k+N_{pbase}·f)
and Nₜ is calculated using the equation:

Nₜ=N_{tBase}·f

Where: Nₚ is the number of rotor poles (12) and is greater than one;
Nₜ is the number of stator teeth (9) and is greater than one;
N_{pBase} is the number of rotor poles (12) in the base model;
N_{tBase} is the number of stator teeth (9) in the base model;
k is a non-negative integer; and
f is a positive integer.

The method may comprise calculating a sector angle α of the one or more cut-out sector using the equation:

$$α = \frac{2 \cdot k}{2 \cdot k + {N}_{pbase} \cdot f} \cdot 360$$

Where: α is the sector angle of the cut-out sector in the stator.

The method may comprise calculating an angular pitch β of the teeth in the stator using the equation:

$$β = \frac{360 - α}{f \cdot {N}_{tBase}}$$

Where: β is the angular pitch of teeth in the stator.

The base model may have the following configuration:
N_{tBase}=9; and
N_{pBase}=8.

According to a further aspect of the present invention there is provided an electric machine comprising a rotor and a stator, the stator having a sector cut-out; wherein the electric machine is configured in dependence on a base model having N_{tBase} stator teeth and N_{pBase} rotor poles, where N_{tBase} and N_{pBase} are both integers greater than one and N_{pBase} is an even number;
the rotor having Nₚ rotor poles, wherein Nₚ is defined by the equation:

Nₚ=(2·k+N_{pbase}·f)
the stator having Nₜ stator teeth, where Nₜ is defined by the equation:

Nₜ=N_{tBase}·f

Where: Nₚ is the number of rotor poles and is greater than one;
Nₜ is the number of stator teeth and is greater than one;
N_{pBase} is the number of rotor poles in the base model;
N_{tBase} is the number of stator teeth in the base model;
k is a non-negative integer; and
f is a positive integer.

A sector angle α of the one or more cut-out sector may be defined by the equation:

$$α = \frac{2 \cdot k}{2 \cdot k + {N}_{pbase} \cdot f} \cdot 360$$

Where: α is the sector angle of the cut-out sector in the stator.

An angular pitch β of the stator teeth 9 is defined by the equation:

$$β = \frac{360 - α}{f \cdot {N}_{tBase}}$$

Where: β is the angular pitch of teeth in the stator.

The stator comprises one or more cut-out segment. This arrangement has particular application where limited space is available for the electric machine. For example, when installed in a vehicle or the like, there may be packaging constraints which impinge on or limit the available space for the electric machine. The packaging constraint may, for example, be the result of packaging a clutch mechanism or other mechanical device, such as a power split device, in close proximity to the electric machine. By including one or more cut-out segment in the stator, the diameter of the rotor may be increased (compared to an electric machine having an annular stator). At least in certain embodiments, this may provide a higher maximum torque. Furthermore, there may be more space available for coils on the stator teeth. The teeth/pole ratio may be lower than 3/2 which is conventional for concentrated winding machines. This may enable higher torque density or lower current density values.

The base model (Base 2) may have the following configuration:
N_{tBase}=9; and
N_{pBase}=8.

According to a further aspect of the present invention there is provided a vehicle comprising an electric machine as described herein. The electric machine may be a traction motor for generating a tractive force to propel the vehicle.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying figures, in which:

FIG. 1 shows a schematic representation of a vehicle incorporating an electric machine in accordance with an embodiment of the present invention;

FIG. 2 shows a sectional view of the electric machine shown in FIG. 1; and

FIG. 3 shows a first coil topology of the windings on the stator of the electric machine shown in Figure.

### DETAILED DESCRIPTION

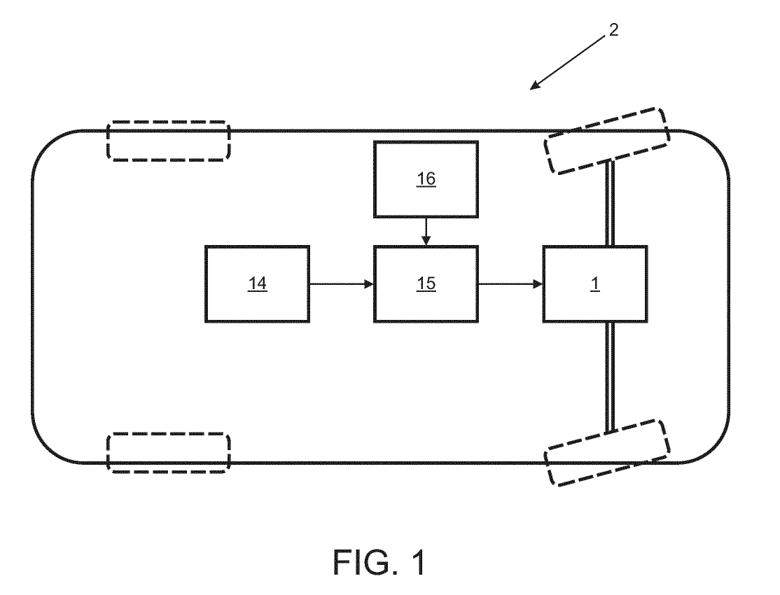

An electric machine 1 in accordance with embodiments of the present invention will now be described by way of example. As illustrated in FIG. 1, the electric machine 1 has particular application in a vehicle 2 to generate a traction force. The electric machine 1 can operate in the traction mode to provide the sole tractive force for propelling the vehicle, for example an electric vehicle (EV); or in conjunction with the internal combustion engine, for example a hybrid electric vehicle (HEV).

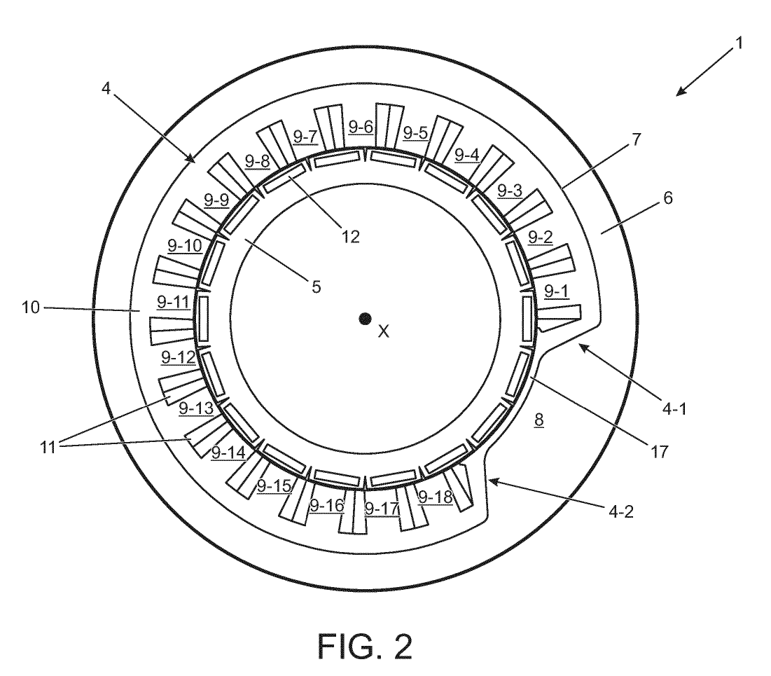

With reference to FIG. 2, the electric machine 1 is a permanent magnet synchronous motor (PMSM). The electric machine 1 is a three-phase machine in the present embodiment. The electric machine 1 comprises a stator 4 and a rotor 5. The rotor 5 is configured to rotate about a longitudinal axis X of the electric machine 1 (extending perpendicular to the plane of the page on FIG. 2). The electric machine 1 is described herein with reference to a transverse cross-section disposed perpendicular to said longitudinal axis X.

The electric machine 1 is installed within a component housing 6, such as a transmission housing, of the vehicle 2. The component housing 6 defines a chamber 7 for the electric machine 1. A protuberance 8 projects inwardly into the chamber 7. The remainder of the chamber 7 has a circular profile in transverse cross-section. The protuberance 8 can, for example, be formed by one or more assembly or machine, such as a power transfer unit or a starter motor, which may be disposed within the chamber 7 or adjacent to the component housing 6.

The stator 4 has a part-annular profile in transverse cross-section. Specifically, the stator 4 consists of a major annular sector in transverse cross-section. The corresponding minor annular sector is an annular gap formed in the stator 4 to accommodate the protuberance 8. Thus, in transverse cross-section, the stator 4 is generally C-shaped and comprises first and second ends 4-1, 4-2 which are separated from each other. As described herein, the angular extent of the major and minor annular sectors is defined to accommodate the protuberance 8. The stator 4 is formed from a plurality of laminations arranged in face-to-face contact with each other to form a stacked core. The laminations can, for example, be made of electrical steel.

The stator 4 comprises a plurality of stator teeth 9 projecting radially inwardly from a radially outer part-annular segment 10. The stator 4 in the present embodiment extends over 300° and comprises eighteen (18) stator teeth 9. The stator teeth 9 are labelled 9-1 through 9-18 in a counter-clockwise direction starting from the first end 4-1 of the stator 4. The stator teeth 9 have an angular spacing (pitch) of 16.67°. Unlike fully swept electric machines (i.e. electric machines having a stator extending over 360°), the angle between the stator teeth 9 is not an integer multiple of 360°. The stator 4 can be formed from one or more segments provided the resulting flux paths are self-contained within each segment. The number of stator teeth 9 in each segment may, for example, be eighteen (18) (as illustrated in FIG. 2), six (6) or two (2). It will be appreciated, therefore, that the stator 4 may have a modular design. The dimensions of each segment can be modified to reduce torque ripple and voltage harmonics.

The rotor 5 has a substantially circular transverse cross-section and is arranged coaxially with the stator 4. The rotor 5 comprises eighteen (18) permanent magnets which form rotor poles 12 having uniform angular spacing around the rotor 5. Thus, the rotor pole pitch is 20° in the present embodiment. The rotor poles 12 are each formed by one or more permanent magnets. The rotor poles 12 can, for example, be made of rare-earth materials to provide a high density of magnetic flux.

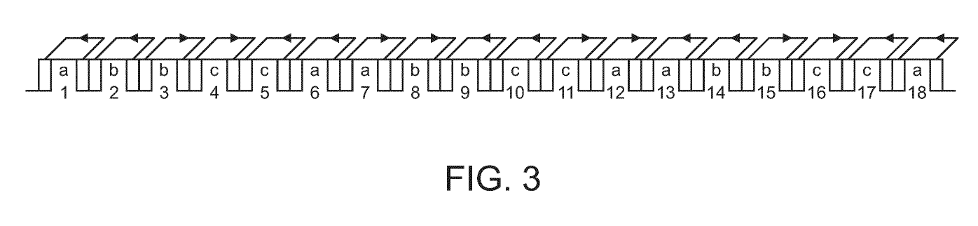

The stator teeth 9 carry windings 11 connected to the 3-phase supply. In the present embodiment the windings 11 are concentrated windings comprising separate coils wound on each stator tooth 9. The phase shift between the windings 11 is 150 electrical degrees. If the windings 11 of two adjacent slots are in the same phase, then these windings 11 are connected with opposite polarity, resulting in a phase shift of 30 electrical degrees. At least in certain embodiments this can enable a higher torque density and/or a lower current density. With reference to FIG. 3, the first coil topology [T1] of the windings 11 is as follows:

−A−B+B+C−C−A+A+B−B−C+C+A−A−B+B+C−C−A [T1]

It will be understood that the first coil topology [T1] defines the phase of the current supplied to the stator teeth 9-1 to 9-18 in a counter-clockwise direction starting from the first end 4-1 of the stator 4. With reference to FIG. 1, the windings 11 are electrically coupled to a high voltage (HV) battery 14 via a first inverter 15. A control unit 16 comprising a first electronic controller (not shown) is provided for sequencing the supply of current to the windings 11. The interaction of the current in the windings 11 and the magnetic flux generated by the permanent magnets in the rotor poles 12 cause the rotor 5 to rotate. The supply sequence is the same as a conventional three (3) phase PMSM having a circular stator. Thus, the electric machine 1 operates in a conventional manner.

With reference to FIG. 2, a circumferential shield element 17 extends between the ends of the stator 4 to reduce the transmittal of magnetic flux from the rotor poles 12 into the component housing 6. However, the first and second ends 4-1, 4-2 of the stator 4 are magnetically isolated and this can result in voltage imbalances within the electric machine 1.

At least in certain embodiments the configuration of the stator 4 helps to reduce the volume of the stator teeth 9 and to lower the back-EMF harmonic content (compared to an equivalent 3/2 topology). The stator 4 may also lower the motor frequency by up to 10% (compared to a known fractional slot topology); and reduce the voltage imbalance in back-EMF of the windings 11 belonging to the same phase (compared to an equivalent 3/2 topology).

The methodology for determining the pole/slot combination of the electric machine 1 to reduce magnetic imbalance will now be described. The term Nₚ defines the number of rotor poles; and the term Nₜ defines the number of stator teeth. A first base model (Base1) and a second base model (Base 2) are defined and form the basis of higher pole/slot combinations for the electric machine 1. The first base model has a 6/5 (stator teeth/rotor pole) configuration (i.e. N_{tBase1}=6/N_{pBase1}=5); and the second base model has a 9/8 (stator teeth/rotor pole) configuration (i.e. N_{tBase2}=9/N_{pBase2}=8). As described below, the first base model forms the basis of the electric machine 1 which is illustrated in FIG. 2 having eighteen (18) stator teeth 9 and eighteen (18) rotor poles 12. It will be understood that additional base models may be defined.

In respect of base models having an odd number of rotor poles 12 (for example, N_{pBase}=5, 7, 9 . . . ), the following set of equations (Equations 1 to 4) are applied. The number of rotor poles (Nₚ) in the electric machine 1 is calculated by applying the equation:

$${N}_{p} = \frac{1 - {( - 1 )}^{f}}{2} + 2 \cdot k + {N}_{pBase} \cdot f \qquad [ Equation 1 ]$$

Where: Nₚ is the number of rotor poles;
N_{pBase} is the number of rotor poles in the base model;
k is a non-negative integer (0, 1, 2, 3 . . . ); and
f is a positive integer (1, 2, 3 . . . ).

The number of stator teeth 9 is calculated using the equation:

Nₜ=N_{tBase}·f [Equation 2]

Where: Nₜ is the number of stator teeth;

N_{tBase} is the number of stator teeth in the base model; and
f is a positive integer (1, 2, 3 . . . ).

An sector angle α of the minor annular (cut-out) sector forming a cut-out in the stator 4 is calculated using the equation:

$$α = \frac{\frac{1 - {( - 1 )}^{f}}{2} + 2 \cdot k}{\frac{1 - {( - 1 )}^{f}}{2} + 2 \cdot k + {N}_{pBase} \cdot f} \cdot 360 \qquad [ Equation 3 ]$$

Where: N_{pBase} is the number of rotor poles in the base model;
k is a non-negative integer (0, 1, 2, 3 . . . ); and
f is a positive integer (1, 2, 3 . . . ).

Furthermore, the angular pitch β of the stator teeth 9 (i.e. the angle between adjacent stator teeth 9) is calculated using the equation:

$$β = \frac{360 - α}{f \cdot {N}_{tBase}} \qquad [ Equation 4 ]$$

where N_{tBase} is the number of stator teeth in the base model; and
f is a positive integer (1, 2, 3 . . . ).

It will be understood that, in order to determine the configuration of the electric machine 1, the non-negative integer k and the positive integer f are constant for each equation. As outlined above, equations 1 to 4 are applied for a base model consisting of an odd number of stator teeth 9, such as the first base model (Base1) having a 6/5 (stator teeth/rotor pole) configuration. By way of example, if the non-negative integer k is set as one (k=1) and the positive integer f is set as three (1=3), the application of equations 1 to 4 using the first base model having a 6/5 (stator teeth/rotor pole) configuration (i.e. N_{tBase1}=6/N_{pBase1}=5) results in the electric machine 1 illustrated in FIG. 2. Specifically, the stator 4 has eighteen (18) stator teeth 9 (Nₜ=18); and the rotor 5 has eighteen (18) rotor poles 12. The sector angle α of the minor annular sector is 60°, such that the angular extent of the major annular sector is 300° (360°-α). The angular pitch β of the teeth 9 in the stator 4 is 16.67°. The configuration of the stator teeth 9 and the rotor poles 12 of the electric machine 1 is such that magnetic imbalance may be reduced.

In respect of base models having an even number of rotor poles (for example, N_{pBase}=8, 10, 12 . . . ), the following set of equations (Equations 5 to 8) are applied. The number of rotor poles (Nₚ) is calculated by applying the equation:

Nₚ=(2·k+N_{pbase}·f) [Equation 5]

Where: Nₚ is the number of rotor poles;
N_{pBase} is the number of rotor poles in the base model;
k is a non-negative integer (0, 1, 2, 3 . . . ); and
f is a positive integer (1, 2, 3 . . . ).

If the non-negative integer k is set as zero (k=0), the electric machine 1 has an arcuate stator 4 extending over 360° (i.e. without a minor annular sector cut-out). The integer k may be specified as a positive integer (i.e. k>0) for an electric machine 1 having a part-arcuate stator 4.

The number of stator teeth 9 is calculated using the equation:

Nₜ=N_{tBase}·f [Equation 6]

Where: Nₜ is the number of stator teeth;
N_{tBase} is the number of stator teeth in the base model; and
f is a positive integer (1, 2, 3 . . . ).

An sector angle α of the minor annular (cut-out) sector forming a cut-out in the stator 4 is calculated using the equation:

$$α = \frac{2 \cdot k}{2 \cdot k + {N}_{pbase} \cdot f} \cdot 360 \qquad [ Equation 7 ]$$

Where: N_{pBase} is the number of rotor poles in the base model;
k is a non-negative integer (0, 1, 2, 3 . . . ); and
f is a positive integer (1, 2, 3 . . . ).

Furthermore, the angular pitch β of the stator teeth 9 is calculated using the equation:

$$β = \frac{360 - α}{f \cdot {N}_{tBase}} \qquad [ Equation 8 ]$$

where N_{tBase} is the number of stator teeth in the base model; and
f is a positive integer (1, 2, 3 . . . ).

It will be understood that, in order to determine the configuration of the electric machine 1, the non-negative integer k and the positive integer f are constant for each equation. As outlined above, equations 5 to 8 are applied for a base model consisting of an even number of stator teeth 9, such as the first base model (Base2) having a 9/8 (stator teeth/rotor pole) configuration. By way of example, if the non-negative integer k is set as one (k=1) and the positive integer f is set as three (1=3), the application of equations 5 to 8 using the second base model having a 9/8 (stator teeth/rotor pole) configuration (i.e. N_{tBase1}=9/N_{pBase1}=8) results in an electric machine 1 having twenty-seven (27) stator teeth 9 (Nₜ=27); and the rotor 5 has twenty-six (26) rotor poles 12 (Nₚ=26). The sector angle α of the minor annular sector is 27.7°, such that the angular extent of the major annular sector is 332.3° (360°-α). The angular pitch β of the teeth 9 in the stator 4 is 12.3°. The configuration of the stator teeth 9 and the rotor poles 12 of the electric machine 1 is such that magnetic imbalance may be reduced.

The present disclosure extends to electric machines 1 having stator teeth 9 and rotor poles 12 configurations which comply with the sets of equations outlined above in respect of the first and second base models.

It will appreciated that further changes can be made to the electric machine 1 described herein without departing from the scope of the present invention.

1-4. (canceled)

5. An electric machine comprising a rotor and a stator, the stator having a sector cut-out; wherein the electric machine is configured in dependence on a base model having N_{tBase} stator teeth and N_{pBase} rotor poles, where N_{tBase} and N_{pBase} are both integers greater than one and N_{pBase} is an odd number;
the rotor having Nₚ rotor poles, wherein Nₚ is defined by the equation:
$${N}_{p} = \frac{1 - {( - 1 )}^{f}}{2} + 2 \cdot k + {N}_{pBase} \cdot f$$
the stator (4) having Nₜ stator teeth (9), where Nₜ is defined by the equation:
Nₜ=N_{tBase}·f
Where: Nₚ is the number of rotor poles and is greater than one;
Nₜ is the number of stator teeth and is greater than one;
N_{pBase} is the number of rotor poles in the base model;
N_{tBase} is the number of stator teeth in the base model;
k is a non-negative integer; and
f is a positive integer;
wherein the base model has the following configuration:
N_{tBase}=6; and
N_{pBase}=5.

6. The electric machine as claimed in claim 5, wherein a sector angle α of the one or more cut-out sector is defined by the equation:
$$α = \frac{\frac{1 - {( - 1 )}^{f}}{2} + 2 \cdot k}{\frac{1 - {( - 1 )}^{f}}{2} + 2 \cdot k + {N}_{pBase} \cdot f} \cdot 360$$
Where: α is the sector angle of the cut-out sector in the stator.

7. The electric machine as claimed in claim 6, wherein an angular pitch β of the teeth in the stator is defined by the equation:
$$β = \frac{360 - a}{f \cdot {N}_{tBase}}$$
Where: β is the angular pitch of teeth in the stator.

8. (canceled)

9. The electric machine as claimed in claim 5, wherein the non-negative integer k is one (k=1) and the positive integer f is three (f=3), the stator having eighteen stator teeth; and the rotor having eighteen poles.

10. The electric machine as claimed in claim 6, wherein the non-negative integer k is one (k=1) and the positive integer f is three (f=3), the stator having eighteen stator teeth; the rotor having eighteen poles; and the sector angle α of the one or more cut-out annular sector is 60°.

11. The electric machine as claimed in claim 7, wherein the non-negative integer k is one (k=1) and the positive integer f is three (f=3), the stator having eighteen stator teeth; the rotor having eighteen poles; and the angular pitch β of the teeth in the stator is 16.67°.

12-15. (canceled)

16. An electric machine comprising a rotor and a stator, the stator consisting of a major annular sector and a minor annular sector, the minor sector being a sector cut-out; wherein the electric machine is configured in dependence on a base model having N_{tBase} stator teeth and N_{pBase} rotor poles, where N_{tBase} and N_{pBase} are both integers greater than one and N_{pBase} is an even number;
the rotor having Nₚ rotor poles, wherein Nₚ is defined by the equation:
Nₚ=(2·k+N_{pbase}·f)
the stator having Nₜ stator teeth, where Nₜ is defined by the equation:
Nₜ=N_{tBase}·f
Where:Nₚ is the number of rotor poles and is greater than one;
Nₜ is the number of stator teeth and is greater than one;
N_{pBase} is the number of rotor poles in the base model;
N_{tBase} is the number of stator teeth in the base model;
k is a non-negative integer; and
f is a positive integer;
wherein the base model has the following configuration:
N_{tBase}=9; and
N_{pBase}=8.

17. The electric machine as claimed in claim 16, wherein a sector angle α of the cut-out sector is defined by the equation:
$$α = \frac{2 \cdot k}{2 \cdot k + {N}_{pbase} \cdot f} \cdot 360$$
Where: α is the sector angle of the cut-out sector in the stator.

18. The electric machine as claimed in claim 17, wherein an angular pitch β of the teeth in the stator is defined by the equation:
$$β = \frac{360 - a}{f \cdot {N}_{tBase}}$$
Where: β is the angular pitch of teeth in the stator.

19. (canceled)

20. A vehicle comprising the electric machine as claimed in claim 16.

21-23. (canceled)

24. A vehicle comprising the electric machine as claimed in claim 1.

25. A method of configuring an electric machine,
the electric machine comprising:
a rotor having Nₚ rotor poles, where Nₚ is the number of rotor poles; and
a stator having one or more cut-out sector and Nₜ stator teeth, where Nₜ is the number of stator teeth;
the method comprising configuring the electric machine in dependence on a base model (Base1) having N_{pBase} stator teeth and N_{pBase} rotor poles, where N_{tBase} and N_{pBase} are both integers greater than one and N_{pBase} is an odd number;
wherein Nₚ is calculated using the equation:
$$α = \frac{1 - {( - 1 )}^{f}}{2} + 2 \cdot k + {N}_{pBase} \cdot f$$
and Nₜ is calculated using the equation:
Nₜ=N_{tBase}·f
Where: Nₚ is the number of rotor poles and is greater than one;
Nₜ is the number of stator teeth and is greater than one;
N_{pBase} is the number of rotor poles in the base model;
N_{tBase} is the number of stator teeth in the base model;
k is a non-negative integer; and
f is a positive integer.

26. The method as claimed in claim 25, further comprising calculating a sector angle α of the one or more cut-out sector using the equation:
$$α = \frac{\frac{1 - {( - 1 )}^{f}}{2} + 2 \cdot k}{\frac{1 - {( - 1 )}^{f}}{2} + 2 \cdot k + {N}_{pBase} \cdot f} \cdot 360$$
Where: α is the sector angle of the cut-out sector in the stator.

27. The method as claimed in claim 26, further comprising calculating an angular pitch β of the teeth in the stator using the equation:
$$β = \frac{360 - α}{f \cdot {N}_{tBase}}$$
Where: β is the angular pitch of teeth in the stator.

28. The method as claimed in claim 25, wherein the base model has the following configuration:
N_{tBase}=6; and
N_{pBase}=⁵.

29. A method of configuring an electric machine,
the electric machine comprising:
a rotor having Nₚ rotor poles, where Nₚ is the number of rotor poles and is greater than one; and
a stator having one or more cut-out sector and Nₜ stator teeth, where Nₜ is the number of stator teeth and is greater than one;
the method comprising configuring the electric machine in dependence on a base model (Base1) having N_{tBase} stator teeth and N_{pBase} rotor poles, where N_{tBase} and N_{pBase} are both integers greater than one and N_{pBase} is an even number;
wherein Nₚ is calculated using the equation:
Nₚ=(2·k N_{pbase}·f)
and Nₜ is calculated using the equation:
Nₜ=N_{tBase}·f
Where: Nₚ is the number of rotor poles and is greater than one;
Nₜ is the number of stator teeth and is greater than one;
N_{pBase} is the number of rotor poles in the base model;
N_{tBase} is the number of stator teeth in the base model;
k is a non-negative integer; and
f is a positive integer.

30. The method as claimed in claim 29, further comprising calculating a sector angle α of the one or more cut-out sector using the equation:
$$α = \frac{2 \cdot k}{2 \cdot k + {N}_{pbase} \cdot f} \cdot 360$$
Where: α is the sector angle of the cut-out sector in the stator.

31. The method as claimed in claim 30, further comprising calculating an angular pitch β of the teeth in the stator using the equation:
$$β = \frac{360 - α}{f \cdot {N}_{tBase}}$$
Where: β is the angular pitch of teeth in the stator.

32. The method as claimed in claim 29, wherein the base model (Base 2) has the following configuration:
N_{tBase}=9; and
N_{pBase}=8.
